(19) United States
(12) Patent Application Publication
(10) Pub. No.: US 2025/0118809 A1
(43) Pub. Date: Apr. 10, 2025

(54) METHOD OF PRODUCING BATTERY, AND BATTERY

(71) Applicant: Toyota Jidosha Kabushiki Kaisha, Toyota-shi (JP)

(72) Inventors: Yosuke SHIMURA, Nagakute-shi (JP); Takahiko Nakano, Nagoya-shi (JP); Hirokazu Takeuchi, Toyota-shi (JP); Masato Noda, Toyota-shi (JP); Atsushi Sugihara, Toyota-shi (JP); Jun Izumi, Toyota-shi (JP); Yuka Yokoi, Nagoya-shi (JP)

(73) Assignee: Toyota Jidosha Kabushiki Kaisha, Toyota-shi (JP)

(21) Appl. No.: 18/906,441

(22) Filed: Oct. 4, 2024

(30) Foreign Application Priority Data
Oct. 10, 2023 (JP) 2023-175531

(51) Int. Cl. H01M 10/0585; H01M 10/052; H01M 50/618

(52) U.S. Cl. CPC H01M 10/0585; H01M 10/052; H01M 50/618

(57) ABSTRACT

A method of producing a battery, the method including: a first process of disposing an electrode body at an internal space of an exterior body; a second process of supplying an electrolytic solution to the internal space of the exterior body at which the electrode body has been disposed; and a third process of pressurizing the exterior body, to which the electrolytic solution has been supplied, at a portion corresponding to a periphery of the electrode body, the internal space of the exterior body being greater in volume than the electrode body.

### CROSS-REFERENCE TO RELATED APPLICATION

This application is based on and claims priority under 35 USC 119 from Japanese Patent Application No. 2023-175531 filed on Oct. 10, 2023, the disclosure of which is incorporated by reference herein.

### BACKGROUND

### Technical Field

The present disclosure relates to a method of producing a battery, and a battery.

### Related Art

Lithium ion secondary batteries are typically produced by injecting an electrolytic solution into an exterior body in which an electrode body, which includes an electrode and a separator, is accommodated. As a means for increasing electrode density, the electrode body is subjected to a treatment such as pressurizing at high pressure or bonding an electrode to a separator with an adhesive or the like. The treatment may hinder permeation of an electrolytic solution into the electrode body, and improvement in efficiency of the liquid injection operation is desired.

As a method for improving the permeability of an electrolytic solution into an electrode body, for example, Japanese Patent Application Laid-Open (JP-A) No. 2002-15773 proposes a method of providing, when bonding an electrode and a separator that constitutes an electrode body, a portion at which the electrode and the separator are not bonded to each other.

Since the method described in JP-A No. 2002-15773 requires a process of providing a portion at which the electrode and the separator are not bonded to each other in order to increase the permeability with respect to an electrolytic solution, there is room for improvement in terms of operating efficiency.

### SUMMARY

In view of the foregoing, an object of an embodiment of the present disclosure is to provide a method of producing a battery, and a battery, in which an electrolytic solution is able to permeate into an electrode body in a simple manner.

The means for solving the above-described problem include the following embodiments.

<1> A method of producing a battery, the method including:
a first process of disposing an electrode body at an internal space of an exterior body;
a second process of supplying an electrolytic solution to the internal space of the exterior body at which the electrode body has been disposed; and
a third process of pressurizing the exterior body, to which the electrolytic solution has been supplied, at a portion corresponding to a periphery of the electrode body,
the internal space of the exterior body being greater in volume than the electrode body.

<2> The method of producing a battery according to <1>, wherein the pressurizing is performed such that the electrolytic solution at the periphery of the electrode body is moved toward the electrode body.

<3> The method of producing a battery according to <1> or <2>, the method including, together with the pressurizing or after the pressurizing, a process of bending the portion of the exterior body corresponding to a periphery of the electrode body toward either one of principal surfaces of the battery.

<4> A battery, including a first exterior body, a second exterior body, and an electrode body disposed between the first exterior body and the second exterior body,
each of the first exterior body and the second exterior body having a region X that contacts the electrode body and a region Y that does not contact the electrode body,
the region Y consisting of a region Y1 at which the first exterior body and the second exterior body are joined and a region Y2 at which the first exterior body and the second exterior body are not joined.

<5> The battery according to <4>, wherein an area of the region Y2 corresponds to 5% or more of an area of the region X.

<6> The battery according to <4> or <5>, wherein an area of the region Y2 corresponds to 5% or more of an area of the region Y1.

<7> The battery according to any one of <4> to <6>, wherein the region Y of the first exterior body and the second exterior body is bent toward either one of principal surfaces of the battery.

According an embodiment of the present disclosure, it is possible to provide a method of producing a battery, and a battery, in which an electrolytic solution is able to permeate into an electrode body in a simple manner.

### BRIEF DESCRIPTION OF THE DRAWINGS

Exemplary embodiments of the present disclosure will be described in detail based on the following figures, wherein:

FIG. 1 is a plan view schematically illustrating an example of a configuration of a battery;

FIG. 2 is a sectional view schematically illustrating an example of a configuration of a battery;

FIG. 3 is a sectional view schematically illustrating an example of a configuration of a battery;

FIG. 4 is a plan view schematically illustrating an example of a configuration of a battery;

FIG. 5 is a sectional view schematically illustrating an example of a configuration of a battery;

FIG. 6 is a sectional view schematically illustrating an example of a configuration of a battery;

FIG. 7 is a diagram schematically illustrating an example of application of a battery to an electric vehicle;

FIG. 8 is a diagram schematically illustrating an example of a configuration of a battery module;

FIG. 9 is a diagram schematically illustrating an example of a configuration of a battery module; and

FIG. 10 is a diagram schematically illustrating an example of a configuration of a battery cell included in a battery module.

### DETAILED DESCRIPTION

In the present disclosure, a numerical range indicated using “to” means a range in which numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “process” includes not only independent processes, and even in a case in which a process cannot be clearly distinguished from another process, it is encompassed by this term as long as the intended purpose of the process is achieved.

In a case in which an exemplary embodiment is explained in the present disclosure with reference to the drawings, the configuration of the exemplary embodiment is not limited to the configuration illustrated in the drawings. Furthermore, sizes of members in the respective drawings are conceptual, and relative relationships between sizes of members are not limited thereto.

### <Method of Producing Battery>

A first embodiment according to the present disclosure is a method of producing a battery, the method including:
a first process of disposing an electrode body at an internal space of an exterior body;
a second process of supplying an electrolytic solution to the internal space of the exterior body at which the electrode body has been disposed; and
a third process of pressurizing the exterior body, to which the electrolytic solution has been supplied, at a portion corresponding a periphery of the electrode body,
the internal space of the exterior body being greater in volume than the electrode body.

In a conventional method of producing a battery, an exterior body for accommodating an electrode body has a volume that is approximately equal to a volume of an electrode body. In addition, a certain period of time is required for an electrolytic solution to permeate into an electrode body. Accordingly, it is difficult to supply, in a single operation, an electrolytic solution to an internal space of an exterior body at an amount to be eventually absorbed by the electrode body.

Therefore, in a conventional method, a first injection process is performed to supply an electrolytic solution at an amount not greater than a volume of an internal space of an exterior body, and an interval is provided to wait for the electrolytic solution to permeate into the electrode body. Thereafter, a second injection process is performed such that a sufficient amount of the electrolytic solution permeates into the electrode body.

In the method of the present disclosure, an exterior body having an internal space that is greater in volume than an electrode body is used. Therefore, it is possible to inject an electrolytic solution at an amount to be eventually absorbed by the electrode body in a single operation.

In the method of the present disclosure, an exterior body used for the production of a battery has an internal space that is greater in volume than an electrode body. Therefore, at the end of the liquid injection operation, electrolytic solution that has not been absorbed by the electrode body remains at a periphery of the electrode body. In the method of the present disclosure, the exterior body is pressurized at a portion corresponding to a periphery of the electrode after the operation for injection. By performing the pressurization, electrolytic solution at the periphery of the electrode body is moved toward the electrode body, thereby promoting the permeation thereof into the electrode body.

According to the method of the present disclosure, for example, it is possible to improve the efficiency of the operation for injection without performing a process to increase the permeability of an electrode body with respect to an electrolytic solution.

In the following, the processes included in the method of the present disclosure are explained.

### (First Process)

In the first process, the electrode body is disposed at an internal space of the exterior body, wherein the internal space of the exterior body is greater in volume than the electrode body.

The type of the exterior body is not particularly limited as long as it can accommodate the electrode body. From the viewpoint of pressurizing the exterior body, to which the electrolytic solution has been supplied, at a portion corresponding a periphery of the electrode body, the exterior body is preferably a flexible sheet-shaped object having a small thickness.

The exterior body may be composed of a single member, or may be composed of two or more members. For example, when the exterior body is a sheet-shaped object, the exterior body may be composited of a single sheet-shaped object, or may be composed of two sheet-shaped objects.

A layered body including a metal layer containing metal such as aluminum and a heat seal layer (i.e., a laminate film) may be used as the exterior body. Therefore, the battery produced by the method of the present disclosure may be a battery using a laminate film as an exterior body (i.e., a laminate battery).

Examples of the method for performing the first process in a case in which a laminate film is used as the exterior body include the following Method 1 and Method 2.

Method 1: a method of, in a state in which the electrode body is disposed between one laminate film that has been folded in half or between two laminate films that have been superposed, joining the laminate film (or laminate films) at a periphery of the electrode body by heat sealing

Method 2: a method of joining a periphery of one laminate film that has been folded in half or two laminate films that have been superposed by heat sealing, and disposing the electrode body at a space surrounded by the joined portion of the laminate film (or laminate films)

As necessary, a recessed portion for accommodating the electrode body may be formed to the laminate film by embossing.

The type of the electrode body is not particularly limited, and may be selected depending on the scale or the purpose of the battery.

For example, a layered body including electrodes (negative electrodes and positive electrodes) and separators that are disposed between the electrodes may be used as the electrode body. The number of the electrodes and the separators included in the electrode body is not particularly limited, and may be selected depending on the scale or the purpose of the battery.

As the separator, for example, a microporous film formed of resin, such as polyethylene, may be used.

### (Second Process)

In the second process, an electrolytic solution is supplied to the internal space of the exterior body at which the electrode body has been disposed.

The method for supplying the electrolytic solution to the internal space of the exterior body is not particularly limited, and may be performed by a known process.

For example, the second process may be performed in such a manner that the opening (an injection port for the electrolytic solution) of the exterior body, in which the electrode body has been disposed, is positioned at the upper side in a direction of gravitational force.

From the viewpoint of increasing the permeability of the electrode body with respect to an electrolytic solution, the internal space of the exterior body may be depressurized prior to supplying the electrolytic solution.

In the second process, the electrolytic solution may be supplied to the internal space of the exterior body in a single process or in multiple processes. From the viewpoint of improving the operation efficiency of the injection process, the electrolytic solution is preferably supplied to the internal space of the exterior body in a single process. Therefore, the exterior body is preferably designed such that the internal space has a volume to which a sufficient amount of electrolytic solution can be supplied in a single process.

In the second process, the electrolytic solution may be supplied to the internal space of the exterior body in such a manner that the electrode body is completely immersed in the electrolytic solution, or that a portion of the electrode body is not immersed in the electrolytic solution.

The method for sealing the opening after supplying the electrolytic solution is not particularly limited, and may be performed by a known method.

### (Third Process)

In the third process, the exterior body, to which the electrolytic solution has been supplied, is pressurized at a portion corresponding to a periphery of the electrode body.

By performing the third process, permeation of the electrolytic solution into the electrode body is promoted by moving the electrolytic solution remaining at the periphery of the electrode body (i.e., the electrolytic solution that has not been absorbed by the electrode body) toward the electrode body.

The method for performing the third process is not particularly limited. For example, the third process may be performed by roll pressing, hand pressing or the like.

The pressurization is preferably performed such that the electrolytic solution at the periphery of the electrode body is moved toward the electrode body. For example, a portion of the exterior body at which a pressure is applied may be moved in a direction of from the edge to the middle (i.e., moved toward the electrode body).

The portion of the exterior body corresponding to the periphery of the electrode body may be bent toward either one of principal surfaces of the battery, together with the pressurizing or after the pressurizing.

By bending the portion of the exterior body corresponding to the periphery of the electrode body, for example, it is possible to save a space in the casing in which the battery is accommodated. Further, it is possible to prevent the electrolytic solution from leaking out around the electrode body.

A pressure may be applied to the electrode body in the thickness direction prior to performing the third process.

By applying a pressure to the electrode body in the thickness direction, it is possible to inhibit the flowage of the electrolytic solution into a space between the electrode body and the exterior body, thereby facilitating the permeation of the electrolytic solution into the electrode body.

From the viewpoint of causing the electrolytic solution to permeate into the electrode body in an efficient manner, the pressure applied to the electrode body is preferably even in the plane direction. Examples of the method of applying an even pressure to the electrode body in the plane direction include applying a pressure to the electrode body using an object having a flat face that faces the electrode, such as a flat panel.

In a case in which a pressure is applied to the electrode body in the thickness direction, it is possible to apply a constant pressure to the electrode body in the thickness direction.

By applying a constant pressure to the electrode body in the thickness direction, for example, it is possible to suppress an excessive increase in the pressure applied to the electrode body in the thickness direction, which may be caused by the electrolytic solution moving from the periphery of the electrode body toward the electrode body, thereby avoiding the breakage of the exterior body.

The method of applying a constant pressure to the electrode body in the thickness direction include a method in which a pressure is applied to the electrode with an object that is movable in the thickness direction of the electrode body, such as a floating panel.

The type of the battery produced by the method of the present disclosure is not particularly limited. For example, the battery produced by the method of the present disclosure may be a battery that satisfies the conditions of the battery of the present disclosure as described below.

### <Battery>

A second embodiment of the present disclosure is a battery, including a first exterior body, a second exterior body, and an electrode body disposed between the first exterior body and the second exterior body,
each of the first exterior body and the second exterior body having a region X that contacts the electrode body and a region Y that does not contact the electrode body,
the region Y consisting of a region Y1 at which the first exterior body and the second exterior body are joined and a region Y2 at which the first exterior body and the second exterior body are not joined.

In the following, the battery of the present disclosure is explained by referring to the drawings.

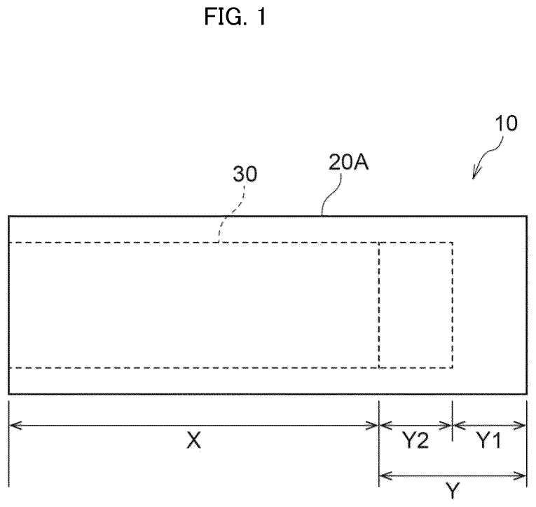

FIG. 1 to FIG. 3 are plan or sectional views schematically illustrating a battery in which the first exterior body and the second exterior body constitutes a continuous single member.

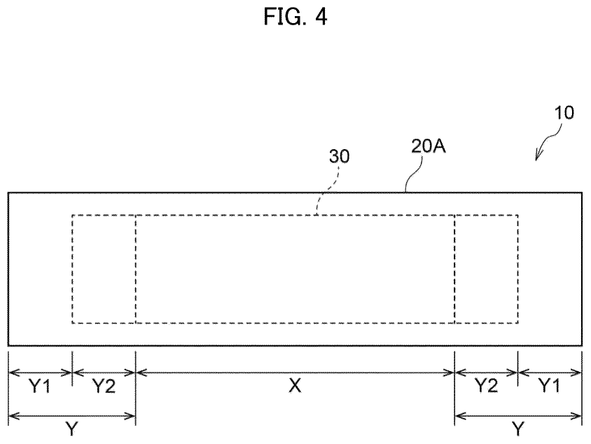

FIG. 4 to FIG. 6 are plan or sectional views schematically illustrating a battery in which the first exterior body and the second exterior body are two members separated from each other.

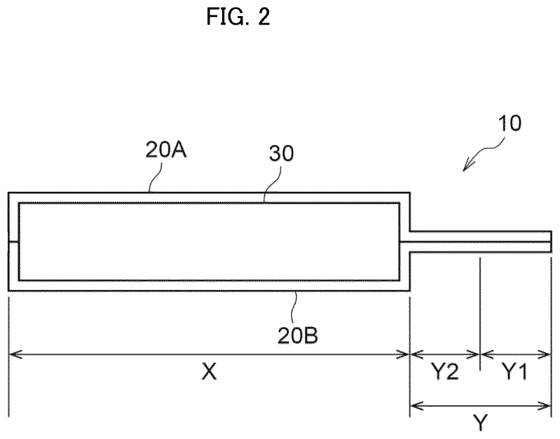

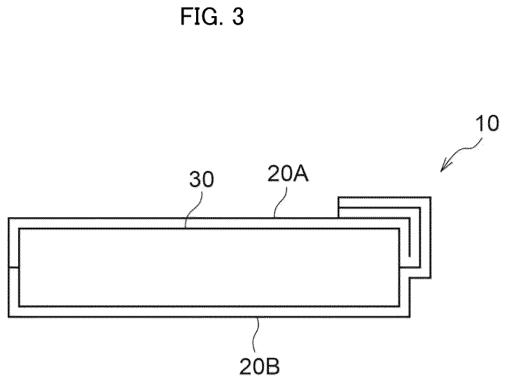

The battery 10 shown in FIG. 1, FIG. 2 and FIG. 3 includes the first exterior body 20A, the second exterior body 20B, and the electrode body 30.

The first exterior body 20A has a region X that contacts the electrode body 30 and a region Y that does not contact the electrode body 30. The region Y consists of a region Y1 at which the first exterior body 20A and the second exterior body 20B are joined and a region Y2 at which the first exterior body 20A and the second exterior body 20B are not joined.

Since the state of the second exterior body 20B in FIG. 1 is the same with the first exterior body 20A, explanation thereof is omitted.

As shown in FIG. 2, the first exterior body 20A and the second exterior body 20B constitutes a continuous single member, and the region Y is provided at the one side of the electrode body 30. While the battery shown in FIG. 2 has a configuration in which a recessed portion for accommodating the electrode body 30 is formed at each of the first exterior body 20A and the second exterior body 20B (double-cup embossing), the battery may have a configuration in which a recessed portion for accommodating the electrode body 30 is formed at either one of the first exterior body 20A or the second exterior body 20B (single-cup embossing).

FIG. 3 is a sectional view of the battery 10 in which a portion corresponding to the region Y of the first exterior body 20A and the second exterior body 20B is bent toward either one of principal surfaces of the battery 10.

The first exterior body 20A and the second exterior body 20B used in the battery 10 have the region X that contacts the electrode body 30 and the region Y that does not contact the electrode body 30, respectively.

Further, the region Y consists of a region Y1 at which the first exterior body 20A and the second exterior body 20B are joined and a region Y2 at which the first exterior body 20A and the second exterior body 20B are not joined.

As such, the volume of the internal space formed between the first exterior body 20A and the second exterior body 20B (i.e., the region X and the region Y2) is greater than the volume of the electrode body 30.

Therefore, it is possible to supply a sufficient amount of electrolytic solution to be absorbed by the electrode body to the internal space of the exterior body in a single process. Further, in the method of the present disclosure, a portion of the first exterior body 20A and the second exterior body 20B, corresponding to the periphery of the electrode body 30 (i.e., the region Y2) is pressurized. Therefore, permeation of the electrolytic solution into the electrode body 30 can be promoted by moving the electrolytic solution at the periphery of the electrode body 30 toward the electrode body 30.

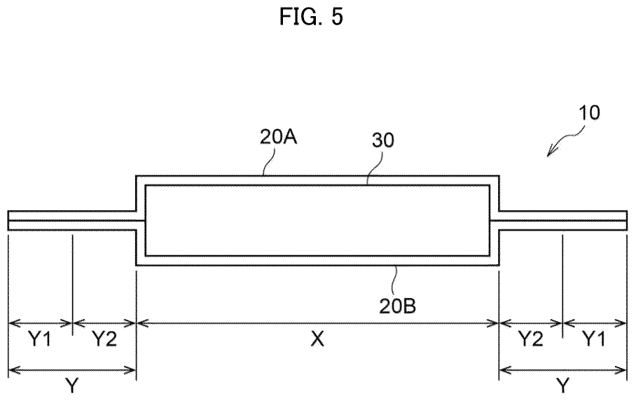

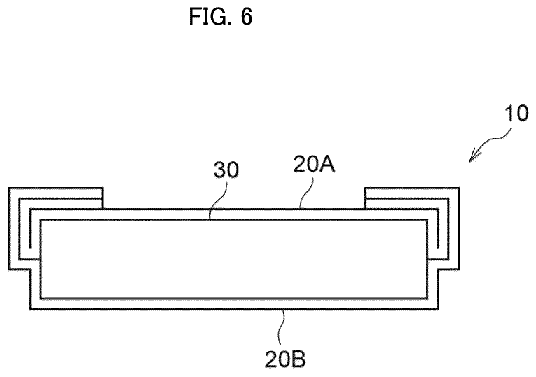

The battery 10 shown in FIG. 4, FIG. 5 and FIG. 6 includes the first exterior body 20A, the second exterior body 20B, and the electrode body 30.

The first exterior body 20A has a region X that contacts the electrode body 30 and a region Y that does not contact the electrode body 30. The region Y consists of a region Y1 at which the first exterior body 20A and the second exterior body 20B are joined and a region Y2 at which the first exterior body 20A and the second exterior body 20B are not joined.

Since the state of the second exterior body 20B in FIG. 4 is the same with the first exterior body 20A, explanation thereof is omitted.

As shown in FIG. 5, the first exterior body 20A and the second exterior body 20B are two members separated from each other, and the region Y is provided at both sides of the electrode body 30. While the battery 10 shown in FIG. 5 has a configuration in which a recessed portion for accommodating the electrode body 30 is formed at each of the first exterior body 20A and the second exterior body 20B (double-cup embossing), the battery 10 may have a configuration in which a recessed portion for accommodating the electrode body 30 is formed at either one of the first exterior body 20A or the second exterior body 20B (single-cup embossing).

FIG. 6 is a sectional view of the battery 10 in which portions of the first exterior body 20A and the second exterior body 20B corresponding to the periphery of the electrode body 30 (i.e., the region Y) are bent toward one of the principal surfaces of the battery 10.

The first exterior body 20A and the second exterior body 20B used in the battery 10 have the region X that contacts the electrode body 30 and the region Y that does not contact the electrode body 30, respectively.

Further, the region Y consists of a region Y1 at which the first exterior body 20A and the second exterior body 20B are joined and a region Y2 at which the first exterior body 20A and the second exterior body 20B are not joined.

As such, the volume of the internal space formed between the first exterior body 20A and the second exterior body 20B (i.e., the region X and the region Y2) is greater than the volume of the electrode body 30.

Therefore, it is possible to supply a sufficient amount of electrolytic solution to be absorbed by the electrode body to the internal space of the exterior body in a single process.

Further, in the method of the present disclosure, a portion of the first exterior body 20A and the second exterior body 20B, corresponding to the periphery of the electrode body 30 (i.e., the region Y2) is pressurized. Therefore, permeation of the electrolytic solution into the electrode body 30 can be promoted by moving the electrolytic solution at the periphery of the electrode body 30 toward the electrode body 30.

The details and preferred embodiments of the electrode body and the exterior body in the battery of the present disclosure are the same with the details and preferred embodiments of the electrode body and the exterior body as described in connection with the method of producing the battery of the present disclosure.

From the viewpoint of improving the efficiency of the operation for injection, the area of the region Y2 in the first exterior body and the second exterior body preferably corresponds to 5% or more, more preferably 10% or more, further preferably 15% or more, of an area of the region X in the first exterior body and the second exterior body.

From the viewpoint of securing an appropriate amount of the joined portion of the first exterior body and the second exterior body, the area of the region Y2 in the first exterior body and the second exterior body preferably corresponds to 35% or less, more preferably 30% or less, further preferably 25% or less, of an area of the region X in the first exterior body and the second exterior body.

From the viewpoint of improving the efficiency of the operation for injection, the area of the region Y2 in the first exterior body and the second exterior body preferably corresponds to 5% or more, more preferably 10% or more, further preferably 15% or more, of an area of the region Y1 in the first exterior body and the second exterior body.

From the viewpoint of securing an appropriate amount of the joined portion of the first exterior body and the second exterior body, the area of the region Y2 in the first exterior body and the second exterior body preferably corresponds to 95% or less, more preferably 90% or less, further preferably 85% or less, of an area of the region Y1 in the first exterior body and the second exterior body.

The battery of the present disclosure may be mounted at an electric vehicle. An example in which the battery of the present disclosure is applied to an electric vehicle will be explained below with reference to the drawings. In the following explanation, a “battery cell 20” corresponds to the battery of the present disclosure.

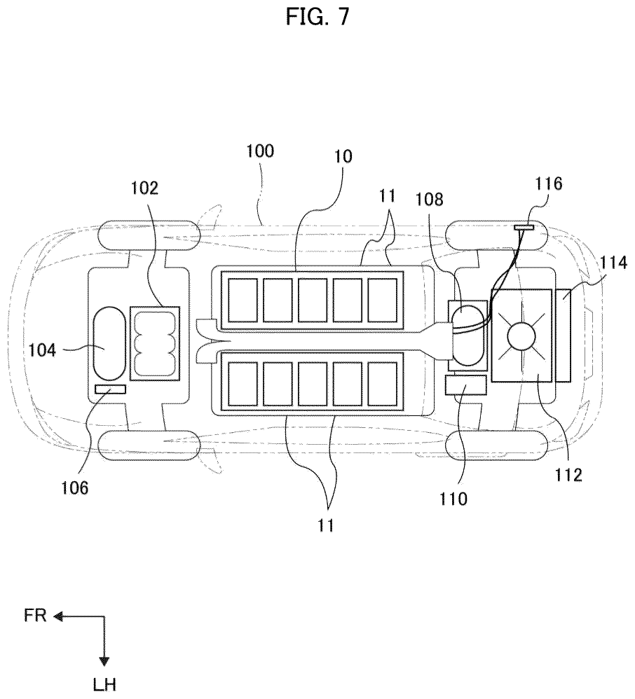

FIG. 7 is a schematic plan view illustrating a main part of a vehicle 100 to which a battery pack 10 according to an embodiment has been applied. As shown in FIG. 7, the vehicle 100 is an electric vehicle (battery electric vehicle (BEV)) at which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present embodiment, a DC/DC converter 102, an electric compressor 104, and a positive temperature coefficient (PTC) heater 106 are arranged further toward a vehicle front side than the battery pack 10. Further, a motor 108, a gear box 110, an inverter 112, and a charger 114 are arranged further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

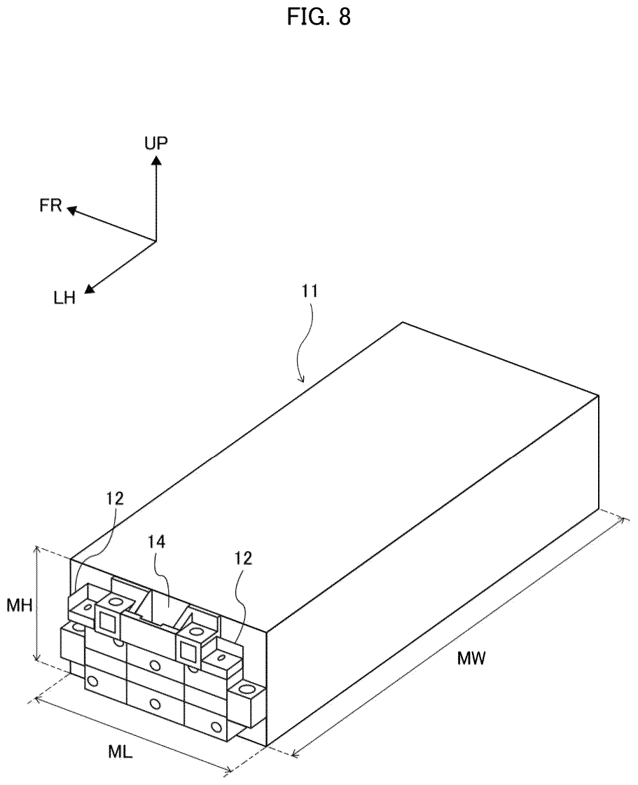

FIG. 8 is a schematic perspective view of a battery module 11. As shown in FIG. 8, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both vehicle width direction end portions of the battery module 11. A flexible printed circuit board 21, which will be described later, is connected to the connector 14. Furthermore, bus bars, which are not illustrated in the drawings, are welded to both vehicle width direction end portions of the battery module 11.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

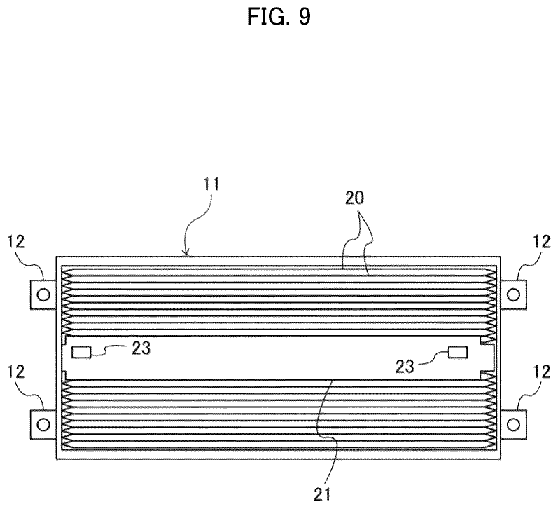

FIG. 9 is a plan view of the battery module 11 in a state in which an upper lid thereof has been removed. As shown in FIG. 9, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are respectively arranged at both end portions in the longitudinal direction of the battery module 11 and at the center portion in the longitudinal direction of the battery module 11, respectively.

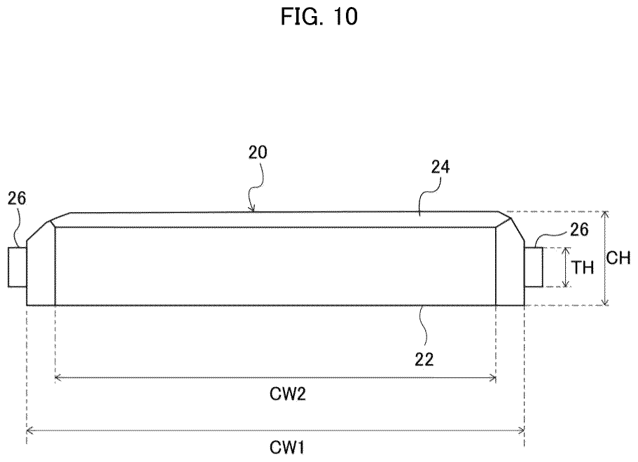

FIG. 10 is a schematic diagram in which a battery cell 20 that is accommodated in the battery module 11 is viewed from a thickness direction thereof. As shown in FIG. 10, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method of producing a battery, the method comprising:
a first process of disposing an electrode body at an internal space of an exterior body;
a second process of supplying an electrolytic solution to the internal space of the exterior body at which the electrode body has been disposed; and
a third process of pressurizing the exterior body, to which the electrolytic solution has been supplied, at a portion corresponding to a periphery of the electrode body,
the internal space of the exterior body being greater in volume than the electrode body.

2. The method of producing a battery according to claim 1, wherein the pressurizing is performed such that the electrolytic solution at the periphery of the electrode body is moved toward the electrode body.

3. The method of producing a battery according to claim 1, the method comprising, together with the pressurizing or after the pressurizing, a process of bending the portion of the exterior body corresponding to a periphery of the electrode body toward either one of principal surfaces of the battery.

4. A battery, comprising a first exterior body, a second exterior body, and an electrode body disposed between the first exterior body and the second exterior body,
each of the first exterior body and the second exterior body having a region X that contacts the electrode body and a region Y that does not contact the electrode body,
the region Y consisting of a region Y1 at which the first exterior body and the second exterior body are joined and a region Y2 at which the first exterior body and the second exterior body are not joined.

5. The battery according to claim 4, wherein an area of the region Y2 corresponds to 5% or more of an area of the region X.

6. The battery according to claim 4, wherein an area of the region Y2 corresponds to 5% or more of an area of the region Y1.

7. The battery according to claim 4, wherein the region Y of the first exterior body and the second exterior body is bent toward either one of principal surfaces of the battery.
